(19) United States
(12) Patent Application Publication
(10) Pub. No.: US 2003/0145105 A1
(43) Pub. Date: Jul. 31, 2003

(54) Method and apparatus for obtaining information about one or more paths terminating at a subject node for a group of packets

(76) Inventors: Harikishan Desineni, Goleta, CA (US); Kameswararao Avasarala, Goleta, CA (US)

Correspondence Address: Daniel J. Chalker, GARDERE WYNNE SEWELL LLP, 1601 Elm Street, Suite 3000, Dallas, TX, 75201-4767, US

(21) Appl. No.: 10/060,136

(22) Filed: Jan. 30, 2002

(51) Int. Cl. G06F 15/173

(52) U.S. Cl. 709/238

(57) ABSTRACT

The present invention provides a method and apparatus for obtaining information about one or more paths terminating at a subject node for a group of packets by determining one or more nodes that are up line from the subject node for the group of packets and propagating a trace request to each node that is up line from the subject node for the group of packets until the trace request is received at all of the ingress nodes for the group of packets. A trace reply responsive to each trace request is then created and sent. At least one trace reply is then received at the subject node. The information about the one or more paths terminating at the subject node for the group of packets is obtained from the trace replies received at the subject node.

### BACKGROUND OF THE INVENTION

Forwarding Equivalence Class (“FEC”) is defined as a group of Internet Protocol (“IP”) packets, which are forwarded in the same manner (e.g., over the same path, with same forwarding treatment). In conventional IP forwarding, as the IP packet traverses the network, each hop in turn reexamines the packet and assigns it to a FEC. In a Multiprotocol Label Switching (“MPLS”) network, the assignment of a particular packet to a particular FEC is done just once, as the packet enters the network. The FEC to which the packet is assigned is encoded as a short fixed length value known as a “label”. When a packet is forwarded to its next hop, the label is sent along with it; that is, the packets are “labeled” before they are forwarded. At subsequent hops, there is no further analysis of the packet's network layer header. Rather, the label is used as an index into a table, which specifies the next hop, and a new label. The old label is replaced with the new label, and the packet is forwarded to its next hop. In the MPLS forwarding paradigm, once a packet is assigned to a FEC, the subsequent routers do not do any further header analysis; instead, the labels drive all of the packet forwarding.

As a result of this unidirectional nature of the Label Switching Paths (“LSP”) formed by the MPLS forwarding paradigm, there is no mechanism to find the set of LSPs terminating on a subject node, which is typically a Label Switching Router (“LSR”), or any information about such LSPs. There is, therefore, a need for a method and apparatus for obtaining information about one or more paths terminating at a subject node for a group of packets.

### SUMMARY OF THE INVENTION

The present invention provides a method and apparatus for obtaining information about one or more paths terminating at a subject node for a group of packets. The present invention, therefore, allows the monitoring and management of a MPLS network, and the LSPs across the MPLS domain. For example, the present invention can also be used to gather various attributes of the LSPs in the set (LSP path, resources available at various nodes along the LSP path, merging information of LSRs in the LSP set). This information can help the network management to monitor/fine tune the set of LSPs terminating on a subject node, such as an egress LSR (Root), for a FEC. This information can also be used to build database capturing various attributes of the traffic engineered (“TE”) paths at various times in the MPLS domain. Two snapshots of a back-traced LSP tree for a FEC at an egress LSR, taken at discrete intervals can reveal information such as changes (re-routed LSPs) in TE paths, upgrade/degrades in LSPs bandwidths, addition of new TE paths to the LSP-Tree, deletion of existing TE paths from the LSP-Tree. Although the subject node will most often be the egress LSR, the present can be performed from any node acting as intermediate LSR for a FEC.

More specifically, the present invention provides a method for obtaining information about one or more paths terminating at a subject node for a group of packets by determining one or more nodes that are up line from the subject node for the group of packets and propagating a trace request to each node that is up line from the subject node for the group of packets until the trace request is received at all of the ingress nodes for the group of packets. A trace reply responsive to each trace request is then created and sent. At least one trace reply is then received at the subject node. The information about the one or more paths terminating at the subject node for the group of packets is obtained from the trace replies received at the subject node. This method can be implemented as a computer program embodied on a computer readable medium wherein the functions described above are implemented by code segments.

The present invention also provides a method for obtaining information one or more paths terminating at a subject node for a group of packets by (a) determining one or more nodes that are up line from the subject node for the group of packets, (b) sending a trace request to each up-line node, (c) performing the process described below at each up-line node, and (d) whenever the trace reply is received at the subject node, obtaining the information about the one or more paths terminating at the subject node for the group of packets from the trace replies received at the subject node. Whenever the trace request is received at an up-line node, the present invention determines if there are any nodes that are up line from the up-line node for the group of packets. If there are any nodes up line from the up-line node for the group of packets, the trace request is forwarded to each up-line node and step (c) is repeated until there are no more up-line nodes. If, however, there are no nodes up line from the up-line node for the group of packets, a trace reply is sent to the node that sent the trace request. Whenever the trace reply is received at the up-line node, the present invention waits until the trace reply has been received from all up-line nodes or until a time out occurs, creates a single trace reply from all of the received trace replies, sends the single trace reply to the node that sent the trace request and repeats step (c) until the up-line node is the subject node. This method can be implemented as a computer program embodied on a computer readable medium wherein the functions described above are implemented by code segments.

Other features and advantages of the present invention will be apparent to those of ordinary skill in the art upon reference to the following detailed description taken in conjunction with the accompanying drawings.

### BRIEF DESCRIPTION OF THE DRAWINGS

For a better understanding of the invention, and to show by way of example how the same may be carried into effect, reference is now made to the detailed description of the invention along with the accompanying figures in which corresponding numerals in the different figures refer to corresponding parts and in which:

FIG. 1 is a block diagram of a network in accordance with one embodiment of the present invention;

FIG. 2 is a block diagram illustrating the trace back mechanism at various types of nodes within a network in accordance with one embodiment of the present invention;

FIGS. 3A, 3B, 3C and 3D are block diagrams illustrating an example of the trace back mechanism in accordance with one embodiment of the present invention;

FIG. 4 is an encoding for a standard label distribution protocol message in accordance with the prior art;

FIG. 5 is an encoding for a back-trace message in accordance with one embodiment of the present invention;

FIG. 6 is an encoding for a back-trace reply message in accordance with one embodiment of the present invention;

FIG. 7 is an encoding for a tree type-length-value in accordance with one embodiment of the present invention;

FIG. 8 is an encoding for an ingress flags type-length-value in accordance with one embodiment of the present invention;

FIG. 9 is an encoding for a reserved bandwidth type-length-value in accordance with one embodiment of the present invention;

FIG. 10 is an encoding for an aggregation type-length-value in accordance with one embodiment of the present invention; and

FIG. 11 is an encoding for the aggregation element described in FIG. 10 in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. For example, in addition to telecommunications systems, the present invention may be applicable to other forms of communications or general data processing. Other forms of communications may include communications between networks, communications via satellite, or any form of communications not yet known to man as of the date of the present invention. The specific embodiments discussed herein are merely illustrative of specific ways to make and use the invention and do not limit the scope of the invention.

The present invention provides a method and apparatus for obtaining information about one or more paths terminating at a subject node for a group of packets. The present invention, therefore, allows the monitoring and management of a Multiprotocol Label Switching (“MPLS”) network, and the Label Switching Paths (“LSP”) across the MPLS domain. For example, the present invention can also be used to gather various attributes of the LSPs in the set (LSP path, resources available at various nodes along the LSP path, merging information of Label Switching Routers (“LSR”) in the LSP set). This information can help the network management to monitor/fine tune the set of LSPs terminating on a subject node, such as an egress LSR (Root), for a Forwarding Equivalence Class (“FEC”). This information can also be used to build database capturing various attributes of the traffic engineered (“TE”) paths at various times in the MPLS domain. Two snapshots of a back-traced LSP tree for a FEC at an egress LSR, taken at discrete intervals can reveal information such as changes (re-routed LSPs) in TE paths, upgrade/degrades in LSPs bandwidths, addition of new TE paths to the LSP-Tree, deletion of existing TE paths from the LSP-Tree. Although the subject node will most often be the egress LSR, the present can be performed from any node acting as intermediate LSR for a FEC.

Referring to FIG. 1, a block diagram of a network 100 in accordance with one embodiment of the present invention is shown. The network is communicably coupled to one or more other networks, such as 102 and 104, via communication links 106, 108, 110 and 112. Network 100 is a MPLS domain that uses a label distribution protocol (“LDP”) and may be all or part of a service provider's packet network. Networks 102 and 104 can be MPLS-LDP networks or some other type of network. As will be recognized by those skilled in the art, the implementation of communication links 106, 108, 110 and 112 will vary depending on the type of interface used between the networks 100, 102 and 104.

Network 100 contains a number of nodes, e.g., 114, 116, 118 and 120, which are communicably coupled together with communication links, e.g., 120, 122 and 124, to form network 100. The nodes 114, 116, 118 and 120 are typically routers and more specifically, label switching routers (“LSR”); but can be any device that performs a routing or switching function. Network 100 operates in accordance with MPLS-LDP standards. As a result, when an IP packet traverses the network 100, each hop, e.g., 120, 122 and 124, in turn reexamines the packet and assigns it to a FEC. A FEC is a group of IP packets, which are forwarded in the same manner (e.g., over the same path, with same forwarding treatment). The assignment of a particular packet to a particular FEC is done just once, as the packet enters the network 100. The FEC to which the packet is assigned is encoded as a short fixed length value known as a “label”. When a packet is forwarded to its next hop, the label is sent along with it; that is, the packets are “labeled” before they are forwarded. At subsequent hops, there is no further analysis of the packet's network layer header. Rather, the label is used as an index into a table, which specifies the next hop, and a new label. The old label is replaced with the new label, and the packet is forwarded to its next hop. Once a packet is assigned to a FEC, the subsequent routers do not do any further header analysis; instead, the labels drive all of the packet forwarding.

Several MPLS-LDP established LSPs for a FEC in network 100 may terminate at the same egress node or LSR for the FEC. This builds a tree of LSPs, with the egress node as the root of the LSP-Tree for a FEC in the MPLS domain. The egress node or root for a FEC acts as the exit for the LSP tree, and hence is the best location to monitor the LSPs merging into it. Given an egress node for a FEC, the present invention uses the unidirectional nature of the LSPs established by MPLS-LDP to back trace all the MPLS-LDP LSPs for that FEC, which terminate on the egress node.

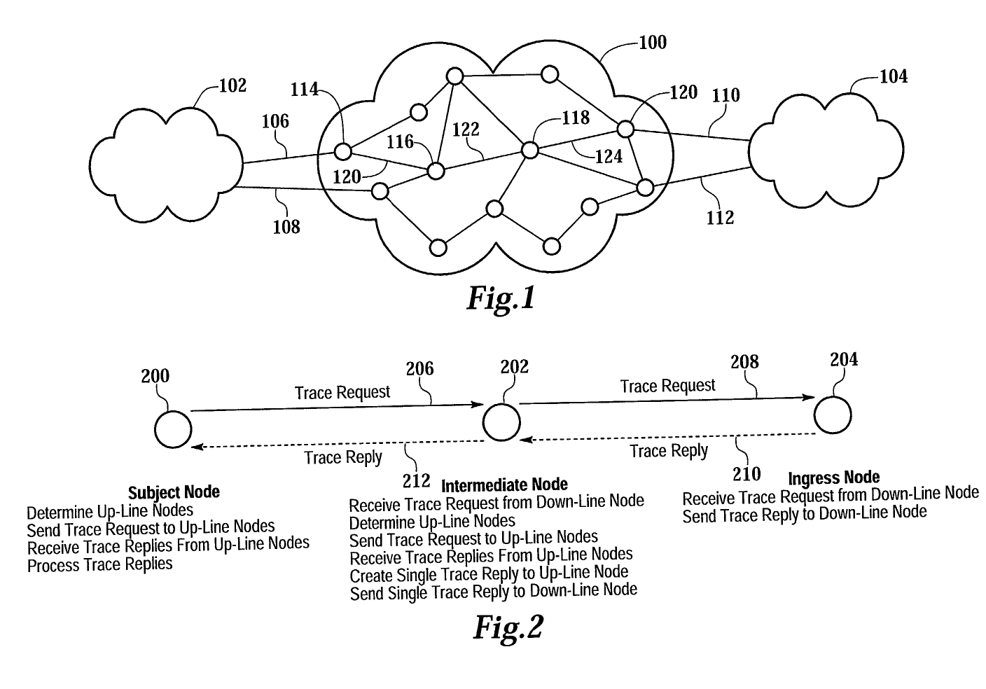

Now referring to FIG. 2, a block diagram illustrating the trace back mechanism at various types of nodes within a network in accordance with one embodiment of the present invention is shown. Any given LSP for a FEC can be identified as a subject node 200, which is often the egress node, one or more intermediate nodes 202 and an ingress node 204. In operation, the present invention determines the up-line nodes from the subject node 200 and sends a trace request 206 to each of the up-line nodes, e.g., intermediate node 202. Each intermediate node 202 receives the trace request 206 from the down-line node, which can be the subject node 200 or a down-line intermediate node. The intermediate node 202 then determines the up-line nodes from the intermediate node 202 and sends a trace request 208 to each of the up-line nodes, which can be the ingress node 204 or an up-line intermediate node. The trace request 206, 208 is propagated using this process to each node that is up line from the subject node 200 for the group of packets until the trace request is received at all of the ingress nodes 204 for the group of packets.

At each ingress node 204, the trace request 208 is processed to create a trace reply or response 210, which is sent to the down-line node, such as intermediate node 202. The trace reply 210 contains various information or attributes about the one or more paths or LSPs in the set (LSP path, resources available at various nodes along the LSP path, merging information of LSRs in the LSP set), or the nodes themselves. This information can help the network management to monitor/fine tune the set of LSPs terminating on a subject node, such as an egress node or LSR (Root), for a FEC. This information can also be used to build database capturing various attributes of the TE paths at various times in the MPLS domain. Two snapshots of a back-traced LSP tree for a FEC at an egress LSR, taken at discrete intervals can reveal information such as changes (re-routed LSPs) in TE paths, upgrade/degrades in LSPs bandwidths, addition of new TE paths to the LSP-Tree, deletion of existing TE paths from the LSP-Tree. Although the subject node will most often be the egress LSR, the present invention can be performed from any node acting as intermediate LSR for a FEC

The down-line intermediate node 202 receives the trace reply 210 from all up-line nodes and creates a single trace reply 212 from all the information contained in the trace replies 210. The trace reply 212 is then sent to the down-line node, which can be the subject node 200 or a down-line intermediate node. This process is repeated at all the intermediate nodes 202 until all of the up-line nodes from the subject node 200 have sent trace replies 212 to the subject node 200. Once all of the trace replies 212 have been received at the subject node 200, the trace replies 212 and the information contained within them are processed for one or more of the purposes described above. For example, the information can be used to adjust one or more of the nodes, create a database or update a database. In addition, the information can be graphically displayed on a computer monitor.

The present invention can also be implemented by (a) determining one or more nodes that are up line from the subject node 200 for the group of packets, (b) sending a trace request 206 to each up-line node 202, (c) performing the process described below at each up-line node 202, and (d) whenever the trace reply 212 is received at the subject node 200, obtaining the information about the one or more paths terminating at the subject node 200 for the group of packets from the trace replies 212 received at the subject node 200. Whenever the trace request 206 is received at an up-line node 202, the present invention determines if there are any nodes that are up line from the up-line node 202 for the group of packets. If there are any nodes up line from the up-line node 202 for the group of packets, the trace request 208 is forwarded to each up-line node 202 or 204 and step (c) is repeated until there are no more up-line nodes 202 or 204. If, however, there are no nodes up line from the up-line node 204 for the group of packets, a trace reply 210 is sent to the node 202 that sent the trace request 208. Whenever the trace reply 210 is received at the up-line node 202, the present invention waits until the trace reply 210 has been received from all up-line nodes 202 and 204 or until a time out occurs, creates a single trace reply 212 from all of the received trace replies 210, sends the single trace reply 212 to the node 200 that sent the trace request 206 and repeats step (c) until the up-line node is the subject node 200. The time out is a configured period of time to collect the trace replies 210 before a single trace reply 212 is created. The time-out period is implementation dependent and should be locally configurable. Thereafter, a single trace reply 212 is created from the trace replies received within the configured period of waiting time and is sent to node 200.

The two methods described above can be implemented as a computer program embodied on a computer readable medium wherein the functions described above are implemented by code segments. In addition, these processes or methods can be repeated (once, several times, periodically or non-periodically) in order to monitor and manage the network and the LSPs. As a result, the information obtained by the present invention can be used to build and update a database capturing various attributes of the TE paths in the MPLS domain.

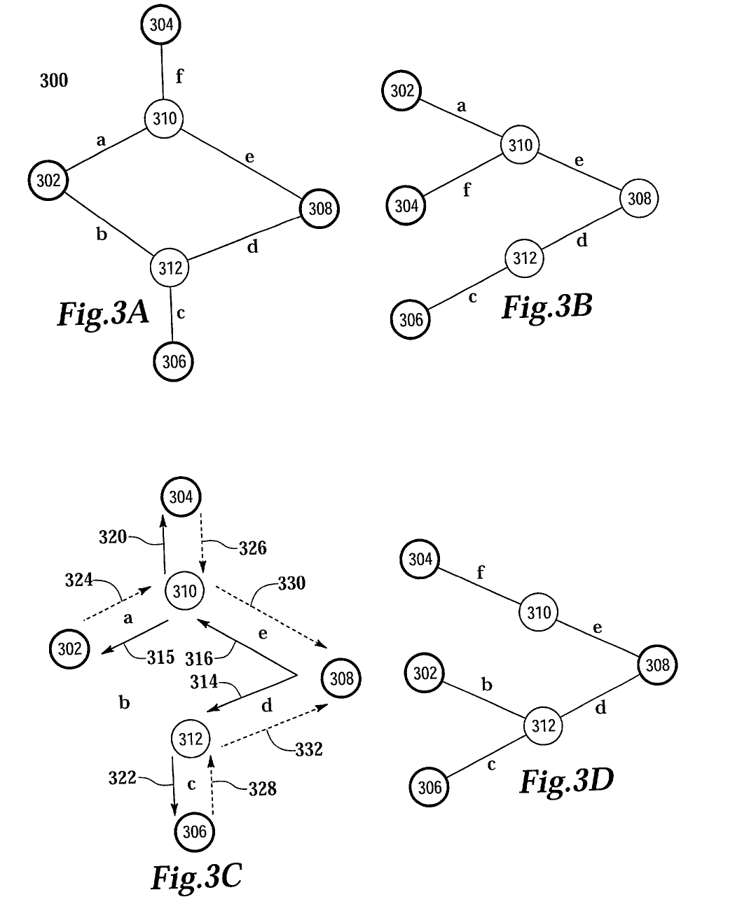

FIGS. 3A, 3B, 3C and 3D are block diagrams illustrating an example of the trace back mechanism in accordance with one embodiment of the present invention. In this example, a network or MPLS domain 300 (see network 100 in FIG. 1) contains six nodes 302, 304, 306, 308, 310 and 312 and six links a, b, c, d, e and f. Nodes 302, 304, 306 and 308, which are marked with a thicker circle, are the edge LSRs of the MPLS domain 300. Also in this example, node 308 is the egress node for FEC “F” and the following LSPs are used for FEC “F” in the MPLS domain 300:

LSP for FEC “F” from node 302 to 308 →{302, a, 310, e, 308};

LSP for FEC “F” from node 304 to 308 →{304, f, 310, e, 308}; and

LSP for FEC “F” from node 306 to 308 →{306, c, 312, d, 308}.

Triggering a LSP back-trace in accordance with the present invention from node 308 should result in the LSP tree shown in FIG. 3B. FIG. 3C shows the flow of LSP Back-Trace request-reply messages for the above case wherein the back trace request messages are shown as solid lines and the back trace reply messages are shown as dashed lines. The lines showing the links 314, 316, 318, 320, 322 and 324 were removed for clarity purposes.

The egress node 308 sends trace request message 314 to node 312 and trace request message 312 to node 310. Node 310 in turn propagates the trace request message 318 to node 302 and trace request message 320 to node 304. At node 312, trace request message 322 is propagated to node 306. As nodes 302, 304 and 306 are ingress nodes for FEC “F”, they respond with back-trace reply messages 324, 326 and 328, respectively. The back-trace reply message from each node includes the sub-tree originating from it, representing the set of LSPs merging at it for FEC “F”. Node 310 collects back-trace reply 324 from node 302 and reply 326 from node 304, appends its own information, builds the new sub-tree with root being it self and sends new back-trace reply 330 to node 308. Node 312 receives the back-trace reply 328 from node 306, appends its own information, builds the new sub-tree with root being it self and sends a new back-trace reply 332 to node 308. Node 308 collets the sub-trees in the back-trace reply 330 from node 310 and reply 332 from node 312, and builds the complete LSP Tree for FEC “F” with root being it self.

Assume that at a later point of time, the LSP from node 302 to node 308 was rerouted to a new path {302, b, 312, d, 308}. If the LSP back-trace is triggered again, the resulting tree should be as shown in FIG. 3D. In addition, the present invention will be able to detect any bandwidth changes in the LSPs {304, f, 310, e, 308} and {306, c, 312, d, 308} whose paths did not change.

The above mechanism builds a LSP tree rooted at an LSR acting as egress for an FEC in the MPLS domain. It is also possible to append additional information to the LSP back-trace message at each node. Additional information could include details such as bandwidth allocated for the LSP over the particular link, amount of unreserved bandwidth on the link, labels used along the LSP, merging capabilities of the node (virtual path (“VP”), virtual circuit (“VC”), VP and VC merges in case of MPLS over ATM), availability of label resources and any other type of information which can be useful for MPLS network management. Sometimes it is possible that the ingress of the LSP is outside the MPLS domain. In such situations, the back-trace message response depends on the local configuration of the edge devices. If the edge device is not configured to propagate the back-trace message into the upstream MPLS domain, it may respond with a back-trace reply with additional information stating that it is not the true ingress of the LSP. Behavior of an edge device when it receives a back-trace request from a downstream MPLS domain depends on its local configuration. LSP back-trace should be able to obtain as much information as possible from the nodes in the MPLS domain. The back-trace mechanism can also be used to build LSP trees spanning across several MPLS domains. For tunneled LSPs, the LSP back-trace message should be propagated at the same LSP level it was originated at, until it reaches the ingress node at the same LSP level, i.e., the back-trace message would not get into different level LSP than it was issued at. The back-trace reply message will not get into different level LSP than the level at which the back-trace message was received. The back-trace response must follow the exact reverse path and same LSP level traversed by the back-trace request message.

One possible implementation of the present invention will now be described that is consistent with the MPLS Architecture. Details of the MPLS Architecture are described in Multiprotocol Label Switching Architecture, RFC 3031, published by The Internet Society (http://www.ietf.org). The LDP contains a set of procedures and messages by which LSRs establish LSPs through a network by mapping network layer routing information directly to data-link layer switched paths. LDP associates a FEC with each LSP it creates. The FEC associated with an LSP specifies, which packets are mapped to that LSP. The LDP is described in the LDP Specification, RFC 3036, published by The Internet Society. In addition, constraint based routing (“CR-LDP”) can be used to extend the information used to setup paths beyond what is available for the routing protocol. The CR-LDP is described in Constraint-Based LSP Setup using LDP, draft-ieft-mpls-cr-ldp-06.txt, published by the Internet Society.

The present invention provides two new LDP messages: Back-Trace Message (also referred to as a trace request message; and Back-trace-Reply Message. The following new Type-Length-Values (“TLV”) are added to accommodate the encoding for the above new messages: Tree TLV; Ingress Flags TLV; Reserved Bandwidth TLV; and Aggregation TLV. The type values for these TLVs are reserved from the LDP TLV space.

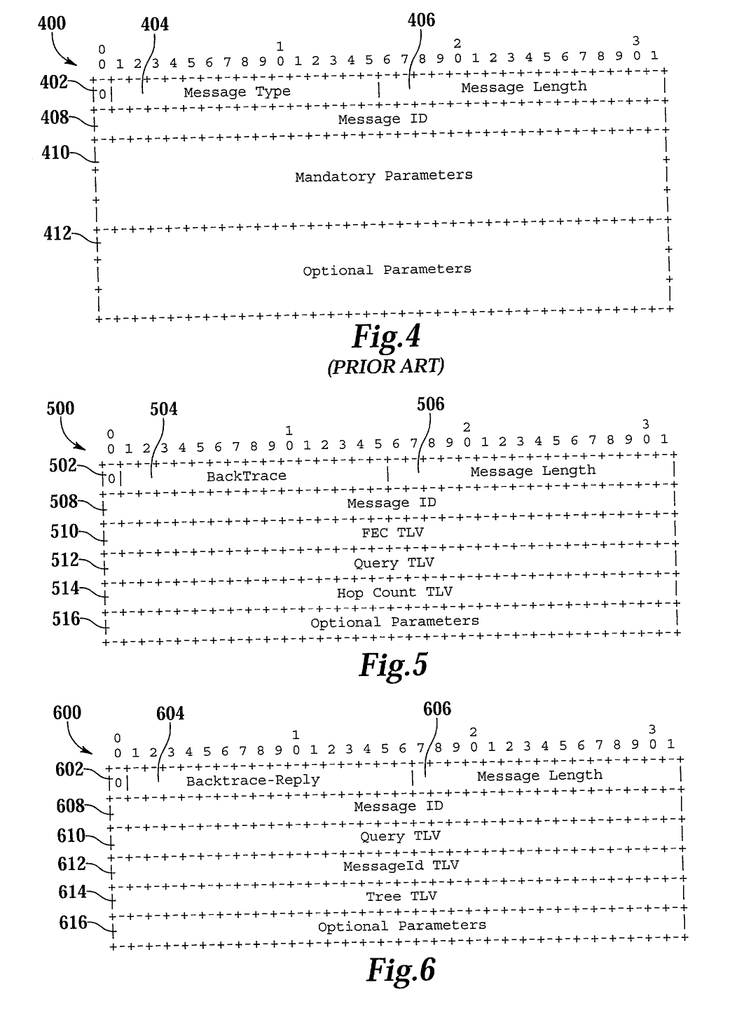

Now briefly referring FIG. 4, an encoding for a standard LDP message 400 in accordance with the prior art is shown. The LDP message 400 contains the following fields: U bit 402; Message Type 404; Message Length 406; Message ID 408; Mandatory Parameters 410; and Optional Parameters 412. The U bit 402 is an unknown message bit. Upon receipt of an unknown message, if U bit 402 is clear (equal to 0), a notification is returned to the message originator; if U bit 402 is set (equal to 1), the unknown message is silently ignored. The Message Type 404 identifies the type of message. The Message Length 406-specifies the cumulative length in octets of the Message ID 408, Mandatory Parameters 410 and Optional Parameters 412. The Message ID 408 is a 32-bit value used to identify the message. The Message ID 408 is used by the sending LSR to facilitate identifying notification messages that may apply to this message. An LSR sending a notification message in response to this message should include this Message ID in the Status TLV carried by the notification message. The Mandatory Parameters 410 is a variable length set of required message parameters. Some messages have no required parameters. For messages that have required parameters, the required parameters MUST appear in the order specified by the individual message specifications in the sections that follow. The Optional Parameters 412 is a variable length set of optional message parameters. Many messages have no optional parameters. For messages that have optional parameters, the optional parameters may appear in any order.

Turning back to the present invention, upon receiving a Back-Trace Message, a LSR will behave according to its configuration constraints in handling the Back-Trace messages and returning the queried information. Several behavioral scenarios are possible for the LSR. First, the LSR does not support the code to handle the messages for the Back-Trace mechanism. Second, the LSR supports the code to handle the messages for the Back-Trace mechanism, but it is configured not to return any data. Third, the LSR supports the code to handle the messages for the Back-Trace mechanism, but it is configured not to return part of the queried data. Finally, the LSR supports the code to handle the messages for the Back-Trace mechanism, and it is configured to return all the data, which is queried. The present invention provides flexibility to handle each of these cases.

In the case where the LSR does not support the Back-Trace messages, the LSR will behave as if it received an unknown message type. It will, therefore, honor the U bit. In the case where the LSR cannot share any information, the LSR is able to decode and process the Back-Trace messages. However, it is configured to hide all the data and will propagate the message to the upstream LSP peers. When Back-Trace Reply Message is received from upstream, the LSR is requested to propagate the reply message downstream after it encodes the zero-length TLVs for the queried data. When the egress node receives back the reply, it can identify which TLVs are empty; it can therefore ignore the zero-length TLVs and process the rest of the data. Note: Zero length TLV encoding can be used for all types of queried information except the merge flag information, True Ingress information and LSP root node information in the Tree TLV. Tree TLV and True Ingress information are described in more detail below. Merge flag information is described in MPLS LDP Query Message Description, draft-ietf-mpls-lsp-query-03.txt, published by The Internet Society.

In the case where the LSR cannot share some of the queried information, the LSR will decode and process and propagate the Back-Trace messages. In the Back-Trace Reply Message, the LSR will encode values for the data types that it is willing to return and zero-length TLVs for values for the data that is hidden. Note: Zero length TLV encoding can be used for all types of queried information except the merge information, True Ingress information and LSP root node information in the Tree TLV. When a LSR is configured to hide its sibling information, it will encode sibling count as 255 in tree TLV. In the case where the LSR can share the queried back-trace information, which is the normal case for an LSR, the LSR's behavior will follow the back-trace and back-trace reply procedures described below. The decision that an LSR can share the back-trace information will be controlled through local configuration.

As previously described, the Back-Trace Message gathers information about an LSP-tree for a FEC. It can be sent at any time for an established LSP. More specifically, the Back-Trace Message can be used to gather information about: LSRs, which form the LSP-Tree of a FEC; Labels used along the LSP-Tree; Information about which LSRs are merging points in the LSP-Tree; Unreserved bandwidth along LSPs forming the LSP-Tree; Allocated bandwidth for LSPs forming the LSP-Tree; Information about FEC aggregation occurring at LSRs in the LSP-Tree; and anything that is needed in future for MPLS network management, which can be computed and encoded in a TLV. The back-trace information is encoded in the Back-Trace Reply Message, which is sent back downstream, as a response to the Back-Trace Message.

Now referring to FIG. 5, an encoding for a Back-Trace Message 500 in accordance with one embodiment of the present invention is shown. The Back-Trace Message 500 contains the following fields: U-bit 502, which is zero; Back-Trace Message Type 504; Message Length 506; Message ID 508; FEC TLV 510; Query TLV 512; Hop Count TLV 514; and Optional Parameters 516. The Message Length 506 specifies the cumulative length in octets of the Message ID 508, FEC TLV 510, Query TLV 512, Hop Count TLV 514 and Optional Parameters 516. The Message ID 508 is a 32-bit value used to identify this message. The FEC TLV 510 includes only one FEC element corresponding to the FEC being back-traced. The Query TLV 512 is used to query additional information about LSPs in the LSP-Tree. Some Query TLV 512 encoding is described in MPLS LDP Query Message Description, draft-ietf-mpls-lsp-query-03.txt, published by The Internet Society. The Hop Count TLV 514 specifies the number of LSR hops that can still be traversed before the message is dropped. This field is typically initialized to the maximum value of 255 (or the configured value, if any). Every LSR that receives the Back-Trace Message will subtract one from the value of Hop Count TLV 514. The Back-Trace Message will be dropped if the value of Hop Count TLV 514 becomes zero. The Optional Parameters 516 is reserved for any optional parameters that may be defined in the future.

In operation, the subject node, which is often an egress LSR, initiates the Back-Trace Message 500 and populates the Query TLV parameters 512 according to what kind of information is to be gathered from all the nodes in the LSP tree for the FEC. However, there are situations in which the Back-Trace Message 500 does not reach all the ingress LSRs for the FEC being back-traced. In this situation, it is still useful for the subject node to gather at least some information about the LSRs, which are along the path, up to the one that failed. Back-trace for a LSP is done by its FEC. Upon receiving a Back-Trace Message 500, an LSR decodes the FEC and finds the out going label to identify the LSP is being back-traced. If the LSR cannot find the LSP, it sends back a Notification message with “No LSP to back-trace” status. Otherwise, the LSR finds the in-coming set of labels, which are merged into the already found out going label. The LSR then computes the upstream LSR peer set “S”, corresponding to each incoming label in the in coming label set. Then, it computes another set “P”, which is a subset of “S” containing only the upstream LSRs, which were advertised a label binding for a FEC, which in-turn either subsumes the FEC received in the Back-Trace Message 500 or is subsumed by the FEC in the Back-Trace Message 500. A mechanism to find the upstream peer for an incoming label can be found in draft-ietf-mpls-ldp-state-04.txt published by The Internet Society.

After computing the upstream LSR peer set, the LSR propagates the Back-Trace Message 500 to all the members of set “P” computed as described above. Sometimes it may be necessary to send more than one Back-Trace Message 500 to the same member of the computed set “P”. This situation arises when a LSR advertises several FEC-Label bindings to an upstream peer, where each of the advertised FECs may either subsume or be subsumed by the FEC received in the back trace request. When the Back-Trace Message 500 gets to a LSP tunnel, it is propagated to the upstream LSP peer at the same LSP level, i.e., the Back-Trace Message 500 should not be propagated to LSP peers at a level different from the LSP level at which it was received.

Upon receiving the Back-Trace Message 500, the ingress node responds with a Back-Trace Reply Message 600 (FIG. 6). The Back-Trace Reply Message 600 contains the Query TLV 512, which was received in the Back-Trace Message 500. The Query TLV 512 tells the LSRs along the path which information is being queried and allows intermediate LSRs to piggy back their own queried information on the Back-Trace Reply Message 600. The Back-Trace Reply Message 600 is propagated downstream and is sent in response to the Back-Trace Message 500. If the Back-Trace Reply Message 600 is full, TCP will take care of it by segmenting and re-assembling the message.

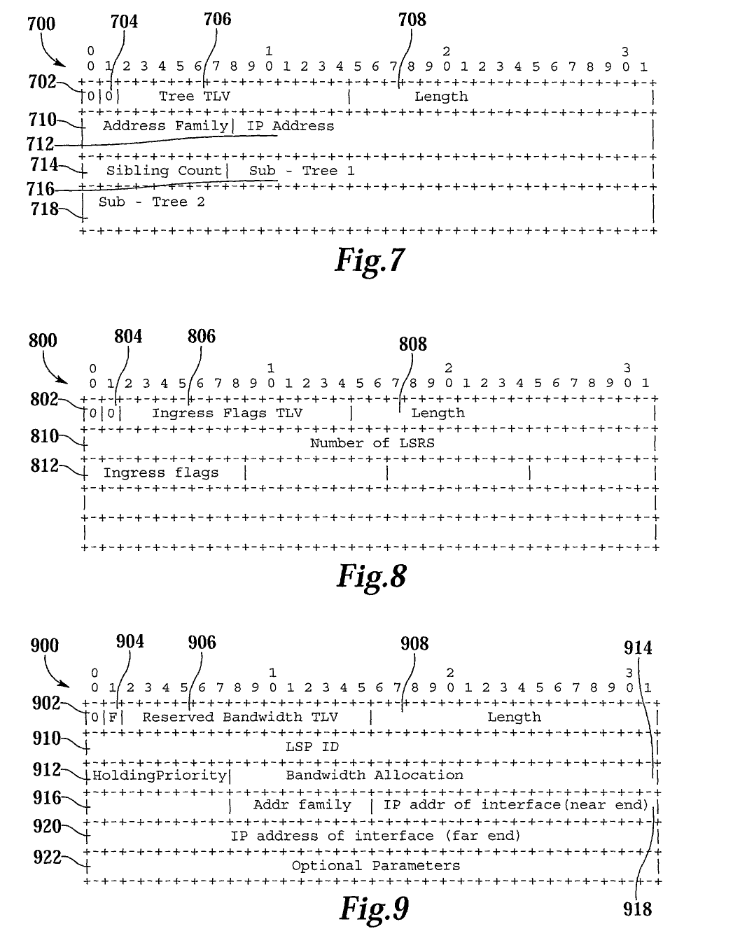

Referring now to FIG. 6, an encoding for a Back-Trace Reply Message 600 in accordance with one embodiment of the present invention is shown. The Back-Trace Reply Message 600 can be generated by any LSR along the LSP-Tree and is sent downstream, by each LSR along the path. The Back-Trace Reply Message 600 contains the following fields: U-bit 602, which is zero; Back-Trace Reply Message Type 604; Message Length 606; Message ID 608; Query TLV 610; Message ID TLV 612; Tree TLV 614; and Optional Parameters 616. The Message Length 606 specifies the cumulative length in octets of the Message ID 608, Query TLV 610, Message ID TLV 612, Tree TLV 614 and Optional Parameters 616. The Message ID 608 is a 32-bit value used to identify this message. The Query TLV 610 is the same as the Query TLV 512 (FIG. 5) contained in the Back-Trace Message 500 (FIG. 5). The Message ID TLV 612 is the value of the Message ID 508 (FIG. 5) of the corresponding Back-Trace Message 500 (FIG. 5). The Tree TLV 614 is described below in reference to FIG. 7. The Optional Parameters 616 is a variable length field that contains zero or more parameters, which are each encoded as a TLV.

The Optional Parameters 616 may include: Query Label TLV; IPV4/6 specified link feedback TLV; Query Merge Flags TLV; Ingress Flags TLV; Reserved Bandwidth TLV; and Aggregation TLV. The Query Label TLV is described in MPLS LDP Query Message Description, draft-ietf-mpls-lsp-query-03.txt, published by The Internet Society. The IPV4/6 specified link feedback TLV is described in Improving Topology Data Base Accuracy with LSP Feedback, draft-ietf-mpls-te-feed-03.txt, published by The Internet Society. The Query Merge Flags TLV is described in MPLS LDP Query Message Description, draft-ietf-mpls-lsp-query-03.txt, published by The Internet Society. The Ingress Flags TLV is a list of a pair of bits that has variable length and every two bits in the mask will correspond to an LSR along the LSP-Tree. The length of the Ingress Flags TLV is rounded up to the next byte. If Q7 is set in Query TLV, every LSR along the path will have to set its corresponding bits in the mask. The bits will be set in the same order as the nodes in the tree TLV. The Reserved Bandwidth TLV informs the bandwidth allocated for the LSP over the out-bound link. Its Q4 is set in Query TLV, every LSR along the LSP-Tree will fill in this information, if it is configured to reveal such information. If an LSR is configured to hide such information, a ZERO Length TLV will be encoded. The Aggregation TLV informs the FEC aggregation occurring along the paths in the LSP-Tree. If the Q5 flag is set in Query TLV, every LSR along the LSP-Tree will fill in this information, if it is configured to reveal such information. If the LSR is performing FEC aggregation, the encoded information includes a FEC, which is either subsumes or subsumed by the FEC being back-traced. The information encoded in the above TLVs is by each LSR and should be in the same order as its information in tree TLV.

In operation, a Back-Trace Reply Message 600 can be generated by any node, which receives a Back-Trace Message 500, if the node is able to identify an LSP for the FEC received. If the node is not able to identify the FEC, it replies with a notification message with “No LSP to back-trace” Status. If the node is an ingress node of the LSP and no upstream peers exist, it can immediately send the Back-Trace Reply Message 600 to the downstream LSP peer. If the node is not an ingress node of the LSP or ingress node, which has upstream peers for this LSP, it waits for the responses from LSRs in the upstream LSP peer (siblings) set “P” to be computed or until a time out occurs as previously described. The time-out period for the responses from upstream LSP peers is implementation dependent and should be locally configurable. Once the time-out period expires, the node will generate a Back-Trace Reply Message 600 with whatever information it has gathered from the upstream LSP peers that have responded within the time-out interval. The gathered LSP sub-tree information is encoded as Tree TLV 614 in the Back-Trace Reply Message 600. Responses received after time-out interval will be ignored.

If the node is not able to propagate the Back-Trace Message 500 to any upstream LSP peer, it will immediately respond with a Back-Trace Reply Message 600 with its own information. This information will state that this node is not a true ingress node for the FEC received in Back-Trace Message 500 through the Ingress Flags TLV in the Back-Trace Reply Message 600. In addition, if a notification message is received from a LSP peer having a status of “No LSP to back-trace” in response to the Back-Trace Message 500, the LSR will stop waiting for a Back-Trace Reply Message 600 from that peer LSR.

Each node will encode a Message ID TLV 612 into the Back-Trace Reply Message 600. The mapping between a Back-Trace Message 500 and a Back-Trace Reply Message is done based on the Message ID 508 and 608. Besides the Message ID TLV 612, each node will encode the information that was queried (bandwidth, merging information, Ingress or Non-Ingress LSR, Aggregation information, etc.,). After the encoding is done, the Back-Trace Reply Message 600 is sent back, on the reversed path, towards the subject or egress node. Every LSR along the LSP tree encodes its information according to what query flags are set. The Back-Trace Reply Message 600 follows the exact reverse path and the same LSP level traversed by Back-Trace Message 500.

The Query TLV 512 travels in the Back-Trace Message 500 until it reaches the ingress node or a node that cannot forward the Back-Trace Message 500 further upstream. The Query TLV 512 then gets copied into a reverse flowing Back-Trace Reply Message 600 as the Query TLV 610 and is used by ingress and intermediate LSRs to know what information is being queried in the back-trace. The extensions to the Query TLV 512 and 610 are as follows. Flags Q3 and Q8 are not used in the Back-Trace Message 500. If they are set, they are ignored by the LSRs along the LSP-Tree. Flags Q4 and Q7 are used to collect allocated bandwidth and ingress information in the LSP-Tree. Flag Q4 queries the bandwidth; if set, the LSR that receives the Back-Trace Message 500 encodes the bandwidth allocated over the outbound link for the LSP. Flag Q5 queries FEC aggregation information. Flag Q7 queries which LSRs in the LSP-Tree act as ingress nodes for the FEC received in Back-Trace Message 500.

Now referring to FIG. 7, an encoding for a Tree TLV 614 in accordance with one embodiment of the present invention is shown. The Tree TLV 614 is a recursive structure capturing a tree. The Tree TLV 614 contains the following fields: U-bit 702, which is zero; F-bit 704, which is zero; Tree TLV Type 706; Length 708; Address Family 710; IP Address 712; Sibling Count 714; and any Sub-Trees, such as Sub-Tree One 716 and Sub-Tree Two 718. The Length 708 specifies the cumulative length in octets of the Address Family 710, IP Address 712, Sibling Count 714, and any Sub-Trees, such as Sub-Tree One 716 and Sub-Tree Two 718. The IP Address 712 is the IP V4/V6 (out-bound port) address of the root node. The IP Address 712 is followed by the Sibling Count 714, which indicates the total number of sub-trees following the present (sub) tree root. The Sibling Count 714 is an 8 bit value with a range of 0-255 wherein the value 255 is reserved to inform that the LSR is not willing to reveal the sibling count. The Sub-Tree structure, such as 716 and 718) follows the Sibling Count 714. The Sibling Count 714 value for leaf nodes in the tree will be zero. The leaf nodes are most likely the ingress points of the LSP. Whether the LSR is true ingress node or not can be found from the Ingress flags TLV.

Referring now to FIG. 8, an encoding for an Ingress Flags TLV 800 in accordance with one embodiment of the present invention is shown. The Ingress Flags TLV 800 contains the following fields: U-bit 802, which is zero; F-bit 804, which is zero; Ingress Flags TLV Type 806; Length 808; Number of LSRs 810; and one or more Ingress Flags 812. The Length 808 specifies the cumulative length in octets of the Number of LSRs 810 and the one or more Ingress Flags 812. The Number of LSRs 810 is a four byte field to store the number of LSRs in the LSP tree. This number is the same as the number of LSRs, which are encoded in the Tree TLV 614. Each two bits in the Ingress Flags 812 represent the ingress node information for an LSR. The Ingress Flags 812 are set to 01 if the LSR is true ingress node for the back-traced LSP and are set to 10 otherwise. If the LSR wants to hide the ingress information, the Ingress Flags are set to 00. The length of the encoding is rounded up to the next byte. Every LSR updates the Number of LSRs 810 and sets the corresponding Ingress Flags 812 accordingly. The ingress information is encoded in the same order as the nodes in the Tree TLV 614.

Now referring to FIG. 9, an encoding for a Reserved Bandwidth TLV 900 in accordance with one embodiment of the present invention is shown. The Reserved Bandwidth TLV 900 contains the following fields: U-bit 902; F-bit 904; Reserved Bandwidth TLV Type 906; Length 908; LSP ID 910; Holding Priority 912; Bandwidth Allocated 914; Address Family 916; IP address of interface (near end) 918; IP address of interface (far end) 920; and Optional Parameters 922. The Length 908 specifies the cumulative length in octets of the LSP ID 910, Holding Priority 912, Bandwidth Allocated 914, Address Family 916, IP address of interface (near end) 918, IP address of interface (far end) 920 and Optional Parameters 922. The LSP ID 910 is the ID of the back-traced CRL-SP. The Holding Priority 912 is the holding priority of the CR-LSP. The Bandwidth Allocated 914 is the bandwidth allocated over the out-bound link of the CR-LSP in bytes per second. The Address Family 916 is the address family of the following two IP addresses in the TLV. The IP address of interface (near end) 918 is the IP address of the interface at the near end. The IP address of interface (far end) 920 is the IP address of the interface at the far end. For example, if the first address is A (near end) and the second address is B (far end), the bandwidth is reserved in the A to B direction. The LSRs along the LSP tree append their reserved bandwidth information to the Back-Trace Reply Message 600. The elements of this vector are encoded in the same order as the nodes in the tree TLV. For example, assume that the Tree TLV 614 {R1, 2, S1, 0, S2, 0} has the reserved bandwidth vector {10, 100}. This indicates that 10 is the bandwidth unit reserved on link between R1 and S1, 100 is the bandwidth unit reserved on the link between R1 and S2. The IP addresses on each side of the link and hold priority of the LSP can be obtained by decoding individual elements of the received bandwidth vector. The Optional Parameters 922 is reserved for future optional parameters.

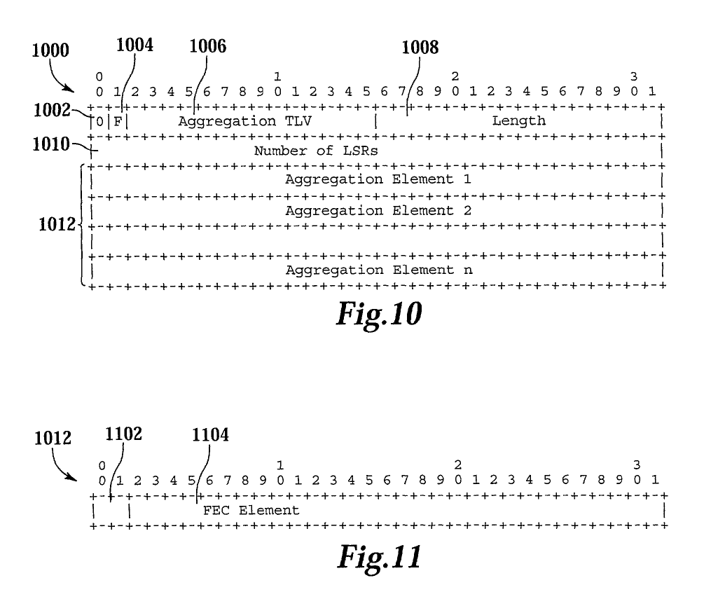

Referring now to FIG. 10, an encoding for an Aggregation TLV 1000 in accordance with one embodiment of the present invention is shown. The Aggregation TLV 1000 is a list of aggregation elements and contains the following fields: U-bit 1002; F-bit 1004; Aggregation TLV Type 1006; Length 1008; Number of LSRs 1010; and one or more Aggregation Elements 1012, such as Aggregation Element 1, Aggregation Element 2 . . . Aggregation Element n. The Length 1008 specifies the cumulative length in octets of the Number of LSRs 1010 and the one or more Aggregation Elements 1012. The Number of LSRs 1010 is a four byte field to store the number of LSRs in the LSP tree. This number is same as the number of LSRs, which are encoded in the Tree TLV 614. The order of the Aggregation Elements 1012-1016 (FEC elements) corresponds to the order of LSRs in Tree TLV 614. The length of Aggregation TLV 1000 encoding is rounded up to the next byte.

Now referring to FIG. 11, an encoding for the Aggregation Element 1012 described in FIG. 10 in accordance with one embodiment of the present invention is shown. The Aggregation Element 1012 contains the following fields: Aggregation Information 1102; and FEC Element 1104. The Aggregation Information 1102 are two bits that represent the aggregation information for an LSR. The bits are set to 01 if the LSR is performing aggregation and are set to 10 otherwise. If the LSR wants to hide the aggregation information, these bits are set to 00. The FEC Element 1104 follows the Aggregation Information 1102. The FEC Element 1104 will not be present if the aggregation bits are set to 10 or 00.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

What is claimed is:

1. A method for obtaining information about one or more paths terminating at a subject node for a group of packets, the method comprising the steps of:
determining one or more nodes that are up line from the subject node for the group of packets;
propagating a trace request to each node that is up line from the subject node for the group of packets until the trace request is received at all of the ingress nodes for the group of packets;
creating and sending a trace reply responsive to each trace request;
receiving at least one trace reply at the subject node; and
obtaining the information about the one or more paths terminating at the subject node for the group of packets from the trace replies received at the subject node.

2. The method as recited in claim 1, further comprising the step of adjusting one or more of the nodes based the information about the one or more paths.

3. The method as recited in claim 1, further comprising the step of creating a database based the information about the one or more paths.

4. The method as recited in claim 1, further comprising the step of updating a database based the information about the one or more paths.

5. The method as recited in claim 1, wherein the subject node is an egress node.

6. The method as recited in claim 1, wherein the subject node is an intermediate node.

7. The method as recited in claim 1, wherein the subject node, ingress nodes and nodes between the subject node and the ingress nodes for the group of packets are routers or switches.

8. The method as recited in claim 7, wherein each router or switch is a label switching router.

9. The method as recited in claim 1, wherein the subject node, ingress nodes and nodes between the subject node and the ingress nodes for the group of packets comprise a multi-protocol label switching domain.

10. The method as recited in claim 1, wherein one or more paths are one or more label switched paths.

11. The method as recited in claim 1, wherein the group of packets is a forwarding equivalence class.

12. The method as recited in claim 1, wherein the information includes an identification of the one or more paths.

13. The method as recited in claim 1, wherein the information includes one or more resources available at each node within the one or more paths.

14. The method as recited in claim 1, wherein the information includes one or more attributes of each node within the one or more paths.

15. The method as recited in claim 1, further comprising the step of graphically displaying the information on a computer monitor.

16. A method for obtaining information one or more paths terminating at a subject node for a group of packets, the method comprising the steps of:
(a) determining one or more nodes that are up line from the subject node for the group of packets;
(b) sending a trace request to each up-line node;
(c) at each up-line node,
whenever the trace request is received, determining if there are any nodes that are up line from the up-line node for the group of packets, whenever there are any nodes up line from the up-line node for the group of packets, forwarding the trace request to each up-line node and repeating step (c) until there are no more up-line nodes, and whenever there are no nodes up line from the up-line node for the group of packets, sending a trace reply to the node that sent the trace request, and
whenever the trace reply is received, waiting until the trace reply has been received from all up-line nodes or until a time out occurs, creating a single trace reply from the received trace replies, sending the single trace reply to the node that sent the trace request and repeating step (c) until the up-line node is the subject node; and
(d) whenever the trace reply is received at the subject node, obtaining the information about the one or more paths terminating at the subject node for the group of packets from the trace replies received at the subject node.

17. The method as recited in claim 16, further comprising the step of repeating steps (a) through (d).

18. The method as recited in claim 17, wherein steps (a) through (d) are repeated periodically.

19. The method as recited in claim 16, further comprising the step of determining any differences between the information obtained.

20. The method as recited in claim 16, wherein the step of obtaining the information about the one or more paths is not performed until the trace reply has been received from all up-line nodes or till a time out occurs.

21. The method as recited in claim 16, further comprising the step of adjusting one or more of the nodes based the information about the one or more paths.

22. The method as recited in claim 16, further comprising the step of creating a database based the information about the one or more paths.

23. The method as recited in claim 16, further comprising the step of updating a database based the information about the one or more paths.

24. The method as recited in claim 16, wherein the subject node is an egress node.

25. The method as recited in claim 16, where in the subject node is an intermediate node.

26. The method as recited in claim 16, wherein the subject node, ingress nodes and nodes between the subject node and the ingress nodes for the group of packets are routers or switches

27. The method as recited in claim 26, wherein each router or switch is a label switching router.

28. The method as recited in claim 16, wherein the subject node, ingress nodes and nodes between the subject node and the ingress nodes for the group of packets comprise a multi-protocol label switching domain.

29. The method as recited in claim 16, wherein one or more paths are one or more label switched paths.

30. The method as recited in claim 16, wherein the group of packets is a forwarding equivalence class.

31. The method as recited in claim 16, wherein the information includes an identification of the one or more paths.

32. The method as recited in claim 16, wherein the information includes one or more resources available at each node within the one or more paths.

33. The method as recited in claim 16, wherein the information includes one or more attributes of each node within the one or more paths.

34. The method as recited in claim 16, further comprising the step of graphically displaying the information on a computer monitor.

35. A computer program embodied on a computer readable medium for obtaining information about one or more paths terminating at a subject node for a group of packets, the computer program comprising:
a code segment for determining one or more nodes that are up line from the subject node for the group of packets;
a code segment for propagating a trace request to each node that is up line from the subject node for the group of packets until the trace request is received at all of the ingress nodes for the group of packets;
a code segment for creating and sending a trace reply responsive to each trace request;
a code segment for receiving at least one trace reply at the subject node; and
a code segment for obtaining the information about the one or more paths terminating at the subject node for the group of packets from the trace replies received at the subject node.

36. The computer program as recited in claim 35, further comprising a code segment for adjusting one or more of the nodes based the information about the one or more paths.

37. The computer program as recited in claim 35, further comprising a code segment for creating a database based the information about the one or more paths.

38. The computer program as recited in claim 35, further comprising a code segment for updating a database based the information about the one or more paths.

39. The computer program as recited in claim 35, wherein the subject node is an egress node.

40. The computer program as recited in claim 35, wherein the subject node is an intermediate node.

41. The computer program as recited in claim 35, wherein the subject node, ingress nodes and nodes between the subject node and the ingress nodes for the group of packets are routers or switches.

42. The computer program as recited in claim 41, wherein each router or switch is a label switching router.

43. The computer program as recited in claim 35, wherein the subject node, ingress nodes and nodes between the subject node and the ingress nodes for the group of packets comprise a multi-protocol label switching domain.

44. The computer program as recited in claim 35, wherein one or more paths are one or more label switched paths.

45. The computer program as recited in claim 35, wherein the group of packets is a forwarding equivalence class.

46. The computer program as recited in claim 35, wherein the information includes an identification of the one or more paths.

47. The computer program as recited in claim 35, wherein the information includes one or more resources available at each node within the one or more paths.

48. The computer program as recited in claim 35, wherein the information includes one or more attributes of each node within the one or more paths.

49. The computer program as recited in claim 35, further comprising a code segment for graphically displaying the information on a computer monitor.

50. A computer program embodied on a computer readable medium for obtaining information one or more paths terminating at a subject node for a group of packets, the computer program comprising:
(a) a code segment for determining one or more nodes that are up line from the subject node for the group of packets;
(b) a code segment for sending a trace request to each up-line node;
(c) a code segment for each up-line node that,
whenever the trace request is received, determines if there are any nodes that are up line from the up-line node for the group of packets, whenever there are any nodes up line from the up-line node for the group of packets, forwards the trace request to each up-line node and repeats code segment (c) until there are no more up-line nodes, and whenever there are no nodes up line from the up-line node for the group of packets, sends a trace reply to the node that sent the trace request, and
whenever the trace reply is received, waits until the trace reply has been received from all up-line nodes or until a time out occurs, creates a single trace reply from all of the received trace replies, sends the single trace reply to the node that sent the trace request and repeats code segment (c) until the up-line node is the subject node; and
(d) a code segment for, whenever the trace reply is received at the subject node, obtaining the information about the one or more paths terminating at the subject node for the group of packets from the trace replies received at the subject node.

51. The computer program as recited in claim 50, further comprising a code segment for repeating code segments (a) through (d).

52. The computer program as recited in claim 51, wherein code segments (a) through (d) are repeated periodically.

53. The computer program as recited in claim 50, further comprising a code segment for determining any differences between the information obtained.

54. The computer program as recited in claim 50, wherein the code segment for obtaining the information about the one or more paths is not performed until the trace reply has been received from all up-line nodes or a time-out occurs.

55. The computer program as recited in claim 50, further comprising a code segment for adjusting one or more of the nodes based the information about the one or more paths.

56. The computer program as recited in claim 50, further comprising a code segment for creating a database based the information about the one or more paths.

57. The computer program as recited in claim 50, further comprising a code segment for updating a database e based the information about the one or more paths.

58. The computer program as recited in claim 50, wherein the subject node is an egress node.

59. The computer program as recited in claim 50, wherein the subject node is an intermediate node.

60. The computer program as recited in claim 50, wherein the subject node, ingress nodes and nodes between the subject node and the ingress nodes for the group of packets are routers or switches.

61. The computer program as recited in claim 60, wherein each router or switch is a label switching router.

62. The computer program as recited in claim 50, wherein the subject node, ingress nodes and nodes between the subject node and the ingress nodes for the group of packets comprise a multi-protocol label switching domain.

63. The computer program as recited in claim 50, wherein one or more paths are one or more label switched paths.

64. The computer program as recited in claim 50, wherein the group of packets is a forwarding equivalence class.

65. The computer program as recited in claim 50, wherein the information includes an identification of the one or more paths.

66. The computer program as recited in claim 50, wherein the information includes one or more resources available at each node within the one or more paths.

67. The computer program as recited in claim 50, wherein the information includes one or more attributes of each node within the one or more paths.

68. The computer program as recited in claim 50, further comprising a code segment for graphically displaying the information on a computer monitor.
